(19) United States
(12) Patent Application Publication
(10) Pub. No.: US 2021/0209700 A1
(43) Pub. Date: Jul. 8, 2021

(54) System, device, and method of match-making

(71) Applicant: MAMA K BEST LTD., Ra'anana (IL)

(72) Inventor: Orly Lubash, Ra'anana (IL)

(21) Appl. No.: 17/058,834

(22) PCT Filed: May 29, 2019
(86) PCT No.: PCT/IL2019/050612

§ 371 Date: Nov. 25, 2020

Related U.S. Application Data
(60) Provisional application No. 62/681,288, filed on Jun. 6, 2018.

(51) Int. Cl. G06Q 50/00; G06Q 10/10; H04L 29/08

(52) U.S. Cl. CPC G06Q 50/01; H04L 67/14; G06Q 10/10

(57) ABSTRACT

System, device, and method of match-making Through a computerized system, a first mother creates a first supervisory account for herself, and creates a first target account for her son. A second mother creates a second supervisory account for herself, and creates a second target account for her daughter. The first mother can search profiles of target accounts (offspring entities) and can search profiles of supervisory accounts (parents). The first mother can initiate private communications with the second mother, to privately propose match-making between the son of the first mother and the daughter of the second mother. Upon approval from both mothers, a private communication session is created between the account of the son and the account of the daughter. A community of supervisory entities (parents) exchange matchmaking information and suggestions via the computerized system; at least some of the communications are not accessible to target entities (offspring entities).

### CROSS-REFERENCE TO RELATED APPLICATIONS

This patent application claims priority and benefit from U.S. 62/681,288, filed on Jun. 6, 2018, which is hereby incorporated by reference in its entirety.

### FIELD

Some embodiments relate to the field of information technology.

### BACKGROUND

Millions of people worldwide utilize electronic devices for various purposes on a daily basis. For example, people utilize a laptop computer, a desktop computer, a smartphone, a tablet, and other electronic devices, in order to send and receive electronic mail (e-mail), to browse the Internet, to play games, to consume audio/video and digital content, to engage in Instant Messaging (IM) and video conferences, to perform online banking transactions and online shopping, and to do various other tasks.

### SUMMARY

The present invention provides systems, devices, and methods of match-making. For example, through a computerized system, a first mother creates a first supervisory account for herself, and creates a first target account for her son. Similarly, a second mother creates a second supervisory account for herself, and creates a second target account for her daughter. The first mother can search profiles of target accounts (offspring entities) and can search profiles of supervisory accounts (parents). The first mother can initiate private communications with the second mother, to privately propose match-making between the son of the first mother and the daughter of the second mother. Upon approval from both mothers, a private communication session is created between the account of the son and the account of the daughter. A community of supervisory entities (e.g., parents, and particularly parents of grown-up children) exchange match-making information and suggestions via the computerized system; at least some of the communications are not accessible to target entities (offspring entities).

### BRIEF DESCRIPTION OF THE DRAWINGS

FIG. 1 is a schematic illustration of a system, in accordance with some demonstrative embodiments of the present invention.

FIG. 2 is a flow-chart of a method demonstrating an “onboarding flow” and a “create profile flow”, in accordance with some demonstrative embodiments of the present invention.

FIG. 3 is a flow-chart of a method demonstrating a “create a match flow”, in accordance with some demonstrative embodiments of the present invention.

FIG. 4 is a flow-chart of a method demonstrating a flow of operations performed by the child or offspring (the match candidate, or the match target), in accordance with some demonstrative embodiments of the present invention.

FIG. 5 is a flow-chart demonstrating a flow of screens or operations in accordance with some embodiments of the invention.

FIGS. 6-10 are schematic illustrations of sets of screens demonstrating GUI, interactions, input and output, in accordance with some demonstrative embodiments of the present invention.

### DETAILED DESCRIPTION

The Applicants have realized that conventional online dating systems and match-making systems require active participation by the two candidates who are the target of a potential match. For example, in order for user Adam to match with user Eve through a conventional online dating system, each one of these users (Adam, Eve) has to actively register with the online dating system, create a profile, answer a lengthy questionnaire, perform active searches for matches (sometimes by using complex search queries with multiple fields and Boolean operators), review search results, initiate communication with the matched party, follow-up on such initial communication, and continue to monitor updates to the search results or to attempt to communicate with other candidates.

The Applicants have realized that such conventional systems and methods are cumbersome, time-consuming, error prone, and/or may require significant time and effort on behalf of each one of the two candidates (Adam, Eve). The Applicants have further realized that a candidate (Adam, Eve) may not have sufficient time or desire to engage in such cumbersome and time-consuming activities; or may prefer to use his or her free time to other activities; thereby removing such potential candidates from the “pool” of candidates available for match-making. This may be particularly true with regard to young, professional, career-oriented candidates, who may be too busy in their professional life as well as in personal activities (e.g., fitness activities, hobbies) and have little or no time for the conventional, time-consuming, effort-consuming, match-making process via a conventional matching system or website. The Applicants have realized that such candidates may benefit if someone else, namely another human user on their behalf and particularly a trusted human user that they generally trust, would perform some or all of the match-making operations on their behalf, thereby saving them time and efforts.

The Applicants have also realized that some potential candidates for match-making may be shy or unwilling to interact with a conventional match-making system, or that feel uneasy or even scared by interacting with an online matching system. The Applicants have realized that such candidates may benefit if someone else, namely another human user on their behalf and particularly a trusted human user that they generally trust, would perform some or all of the match-making operations on their behalf.

The Applicants have further realized that some candidates may be illiterate, or may be foreigners or newcomers to a country who are not proficient in writing or reading the local language. The Applicants have realized that such candidates may benefit if someone else, namely another human user on their behalf and particularly a trusted human user that they generally trust, would perform some or all of the match-making operations on their behalf.

The Applicants have also realized that some candidates avoid using a conventional matching system, since they are looking for a “serious” or “long term” or “marriage oriented” relationship, and they regard a conventional matching system as a system that is more targeted towards “casual” or “short term” or “non-serious” dating or sexual encounters. The Applicants have realized that such candidates may benefit if someone else, namely another human user on their behalf and particularly a trusted human user that they generally trust, would perform some or all of the match-making operations on their behalf, and if that trusted person would provide his or her “seal of approval” with regard to the estimated “seriousness” or eligibility of the other party.

The present invention provides a novel matching system, match-making system, dating system, and profile-matching system, which may operate via a computerized system, which allows parents to perform some or all of the match-making operations on behalf of their children or for their children.

For example, the mother of user Adam creates an online dating profile with regard to her son Adam; the mother of user Eve creates an online dating profile with regard to her daughter Eve; the mother of Adam receives from the matching system one or more search results or matching notifications, for example, an indication that user Eve may be a fitting match for her son, user Adam. Each mother also creates her own profile, namely, a mother's profile or a parent profile; thereby allowing such mothers (or parents) to communicate among themselves and to perform searches and initial inquiries on their own, prior to actually match-making their children with each other. Accordingly, a match-making scenario in accordance with the present invention may involve and may include, for example: a Mother Account of the mother of Adam, with her unique username and her unique password; a Mother Account of the mother of Eve, with her unique username and her unique password; an Account of Adam, with his unique username and his unique password, and with a linkage to or association with the account of his Mother; and an Account of Even, with her unique username and her unique password, and with a linkage to or association with the account of her Mother. Therefore, four accounts, having four respective sets of credentials (namely, four respective pairs of username and password), are utilizes by these four entities for the machine-assisted or computer-assisted match-making process of the present invention.

The mother of Adam may decide, without requiring Adam to know or to approve, that user Eve is not a good match for Adam, and may discard or delete the suggested match; and in such case, the matching system does not further create a match between Adam and Eve, and does not enable communications between Adam and Eve, or between their respective mothers.

Alternatively, the mother of Adam may decide, without requiring Adam to know or to approve, that user Eve may be a good match for Adam; and in such case, the mother of Adam may initiate a communication that is directed not to Adam, and not to Even, but rather to the mother of Eve; in the communication, the mother of Adam notifies the mother of Eve that Adam and Eve may be a good match. The mother of Eve receives the communication from the mother of Adam, and evaluates how to proceed.

For example, the mother of Eve may determine that the proposed candidate Adam is not a good match for her daughter Eve, and may reject or discard the notification from the mother of Adam. In such case, the matching system does not further create a match between Adam and Eve, and does not enable communications between Adam and Eve, or between their respective mothers.

Alternatively, the mother of Eve may determine that the proposed candidate Adam may be a good match for her daughter Eve. Optionally, the mother of Eve may communicate back-and-forth with the mother of Adam, to ask each other questions about Adam or Eve, in order to better estimate by the two mothers whether their children are indeed a good match.

If the mother of Eve determines that Adam is a good match for Eve, then the system may proceed to perform one or more suitable operations in order to enable direct communication between Adam and Eve. For example, the system may send a message to Eve, indicating that “your mother had reviewed the online profile of Adam, and had also communicated with Adam's mother, and your mother believes that Adam is a good match for you”; and the system may provide to Eve one or more methods for direct communications with user Adam, for example, his email address, his telephone number, his user-name or screen-name in a private messaging system, a virtual “inbox/email” system that enables secure and private exchange of text messages and/or multimedia items (audio, video, animations, attached files). This may allow Eve to directly contact Adam with regard to further exploring their mutual interests.

Alternatively, for example, upon the approval of Eve's mother, the system may send a message only to Adam, indicating that “your mother had reviewed the online profile of Eve, and had also communicated with Eve's mother, and your mother believes that Eve is a good match for you”; and the system may provide to Adam one or more methods for direct communications with Eve, for example, her email address, her telephone number, her user-name or screen-name in a private messaging system, a virtual “inbox/email” system that enables secure and private exchange of text messages and/or multimedia items (audio, video, animations, attached files). This may allow Adam to directly contact Eve with regard to further exploring their mutual interests.

Alternatively, for example, upon the approval of Eve's mother, the system may send a message (or two different messages) to both Adam and Eve, notifying them that their mothers had reviewed their data and that their mothers believe that Adam and Even are a good match; and providing both Adam and Eve with direct or indirect communication details.

Alternatively, for example, upon the approval of Eve's mother, the system may send a notification only to Eve, notifying Eve that her mother believes that Adam is a good match for her, and also notifying Eve that also Adam's mother believes so, and asking Eve to grant her permission to enable direct and private communication between Eve and Adam. If Eve grants the permission, then the system enables such direct communication between Eve and Adam and vice versa, for example, via a virtual chat-room or instant messaging or via email or other electronic communication means. Alternatively, if Eve declines, or if Eve does not give the permission within a pre-defined time period (e.g., within 3 days, within 7 days, or the like), then the system discards this match and/or does not create a direct communication channel between Adam and Eve; and optionally, the system may notify the mother of Eve and the mother of Adam that Eve declined to proceed.

Alternatively, for example, upon the approval of Eve's mother, the system may send a notification only to Adam, notifying Adam that his mother believes that Eve is a good match for him, and also notifying Adam that also Eve's mother believes so, and asking Adam to grant his permission to enable direct and private communication between Eve and Adam. If Adam grants the permission, then the system enables such direct communication between Eve and Adam and vice versa, for example, via a virtual chat-room or instant messaging or via email or other electronic communication means. Alternatively, if Adam declines, or if Adam does not give the permission within a pre-defined time period (e.g., within 3 days, within 7 days, or the like), then the system discards this match and/or does not create a direct communication channel between Adam and Eve; and optionally, the system may notify the mother of Eve and the mother of Adam that Eve declined to proceed.

Alternatively, for example, upon the approval of Eve's mother, the system may send notifications to both Eve and Adam, notifying each one of them that their mothers believe that they are a good match; and asking each one of them to grant permission to enable direct and private communication between Eve and Adam. If both Adam and Eve grant their permission, then the system enables such direct communication between Eve and Adam and vice versa, for example, via a virtual chat-room or instant messaging or via email or other electronic communication means. Alternatively, if Adam and/or Eve decline(s), or if Adam and/or Eve does not (or do not) give permission within a pre-defined time period (e.g., within 3 days, within 7 days, or the like), then the system discards this match and/or does not create a direct communication channel between Adam and Eve; and optionally, the system may notify the mother of Eve and the mother of Adam that Adam and/or Eve declined to proceed.

In some embodiments, the system may be configured such that only mothers of a particular gender or type of candidate, may initiate contact with the mother(s) of other candidates. For example, in some implementations, only mothers of female candidates, may initiate communications towards mothers of other candidates (e.g., towards mothers of male candidates); such that a mother of a male candidate cannot initiate a first contact with a mother of a female candidate; such implementation may provide a certain advantage to female candidates and/or their mothers, who have the “first move” advantage in the match-making process; and may facilitate the process, for example, for a shy female candidate who may be reluctant to proceed in a matching process that was initiated by the mother of the other candidate. In other implementations, the opposite configuration may be used; for example, such that only mothers of male candidates, may initiate communications towards mothers of other candidates (e.g., towards mothers of female candidates); such that a mother of a female candidate cannot initiate a first contact with a mother of a male candidate; such implementation may provide a certain advantage to male candidates and/or their mothers, who have the “first move” advantage in the match-making process; and may facilitate the process, for example, for a shy male candidate who may be reluctant to proceed in a matching process that was initiated by the mother of the other candidate.

In some embodiments, mothers and/or candidates may utilize one or more suitable methods or User Interface (UI) elements or Graphic User Interface (GUI) elements, to indicate their consent or approval, or to indicate their refusal or disapproval. In some implementations, a user may “swipe to the right” to indicate approval, and may “swipe to the left” to indicate disapproval. In other implementations, the user may click or tap on on-screen buttons or links or hyper-links or shortcuts, or may choose an option from a drop-down menu, to indicate approval or disapproval. In some implementations, the user may utilize only non-swipe motions or gestures; for example, the user may utilize one or more available GUI elements or motions or gestures, which are not swipe-right or swipe-left. In some implementations, users may provide audible input which may be captured and/or parsed via a speech-to-text unit (e.g., local or remote), enabling the user to utter “yes” or “no” or “I approve” or “I decline” or to provide other verbal input that the system may then recognize and utilize. Some embodiments may utilize other suitable types of input methods or input means.

For demonstrative purposes, portions of the discussion herein may relate to a “female” candidate that is matched with a “male” candidate, such as in a generally heterosexual relationship; however, some embodiments of the present invention may similarly be used in conjunction with same-sex or same-gender matching between a female and a female, or between a male and a male, or between persons whose gender classification is different from classic classification into “male” and “female”. For example, the mother of Eve may know that her daughter Eve is a female that seeks female companionship; the mother of Barbara may know that her daughter Barbara is a female that seeks female companionship; ad the system may be utilized by the mother of Barbara and by the mother of Eve, to enable match-making of their daughters (Barbara, Eve); for example, by each one of these mothers indicating in the online profiles (that they create with regard to Barbara and Eve) that they are “female, seeking female”.

For demonstrative purposes, portions of the discussion herein may relate to a “mother” as the person that performs one or more of the online match-making operations for the purposes of finding a match to her “child”; however, some embodiments of the present invention may similarly operate with regard to other types of parties; for example, a father performing matching operations for his child; a step-mother or step-father, performing matching operations for a step-son or step-daughter; an aunt or uncle, performing matching operations for a nephew or niece; a grandparent performing matching operations for a grandchild; a cousin or other family-member performing matching operations for a relative; and in some implementations, a person performing matching operations for his (or her) friend. It is also clarified that the utilization of the terms “child”, “children”, “kid” or “kids” should not imply that such persons are necessarily minors or non-adults; but rather, such terms may be, or may include, or may exclusively include (in some implementations), persons that are adults or non-minors. In some implementations, the system of the present invention may be utilized by a match-making user who is not a family member or a family relative of the candidate user; for example, the system may be used by a professional match-maker, or by a person whose hobby or his personal interest is to perform match-making operations among other people. Accordingly, the terms “mother” and “child” that are used herein, as well as similar terms that are used herein, may further comprise any such other combination of a “match-making user” or a “recommending user” or a “supervisor user” or a “consulting user” (the person that attempts to do the match-making on behalf of another person) and a “candidate user” or a “matched user” or a “user-to-be-matched” or a “target user” (the person who is the target of the match-making attempt).

In some implementations, optionally, the system may be restricted for utilization only by a particular type of users (e.g., only mothers; or, only parents); and may require a user to declare and/or to prove that the user indeed has the required properties prior to engaging with the system (e.g., requiring a user to submit a photo of her driver license and a copy of the birth certificate of her child, to prove mother and son relationship).

In some implementations, a first system may be dedicated to match-making performed by mothers for their children; a second, different, system may be dedicated to match-making performed by grandparents for their grandchildren; and so forth. In some implementations, a first system may be dedicated to matchmaking performed by a first set of users (e.g., mother, fathers, mothers-in-law, fathers-in-law); and a second, different, system may be dedicated to match-making performed by a second set of users (e.g., grandparents, aunts, uncles).

In some embodiments, the system may be implemented as a stand-alone system that is built from scratch or “from the ground up”; namely, by having each user (e.g., mother) register and create a brand-new account, and then create a detailed profile regarding the user's son or daughter; independently and without relation to any other network or social network that the mother and/or the child may participate in. In other embodiments, the system may be implemented as an add-on or extension or plug-in to a social networking system or network or website or application or “app, or may otherwise “piggyback” on such network or system or app, or may co-operate with such other network or system or app, or may exchange information with it; for example, in order to shorten the time needed for a parent to create profile(s) for herself and/or for her children, and/or to facilitate communications among users, and/or to benefit from an already-existing database that stored user data or user profiles.

Some embodiments enable a parent to find a match for their grown-up kid or offspring, and introduce a new method in online dating that fuses mothers' or parents' wisdom and networks to offer a less superficial alternative to anonymous swipe-based dating sites or dating systems. The Applicants have realized that mothers, or fathers or parents, spend time, energy, efforts and money to ensure that their children make healthy lifestyles choices, get a great education, and obtain top jobs. The Applicants have realized that with little time left in their busy social and work lives, many young persons who wish to find a partner, turn to meaningless swipe-based apps that leave them frustrated.

The Applicants have realized that conventional dating systems have promoted an endemic instant gratification culture, leading users to grow weary fast as their hopes of finding a partner remain unfulfilled; and once they are disillusioned, they leave with their goal unmet. The Applicants have also realized that conventional dating systems tend to have questionable credibility with regards to user identification. The Applicants have realized that a match-making system can utilize a whole new market-segment of untapped users, namely the market-segment of mothers (or parents), who can be regarded as a trusted party that operates to achieve the best for their children. The Applicants have also realized that if a dating candidate is in the age range of 18 to 30, then his or her mother may be (for example) in the age range of 40 to 60, and may be a tech-savvy person that is not stranger to an online platform, and may actually have free time that can be harnessed by a new type of match-making system; particularly when the children (or some of them) already left the home to college or to reside on their own.

The Applicants have also realized that while the dating candidate himself or herself, may “give up” after a few failed attempts that lead to frustration, the mother (or parent) may have a clearer agenda that may cause her to continue and to stay engaged until they succeed in finding the desired match for their son or daughter. The Applicants have realized that such unique system may be beneficial, particularly when young persons are busier than every before, while their mothers (or parents) are tech-savvy more than ever before.

The present invention provides a unique digital platform for mothers (or parents) to assist their kids in finding a match in a safe environment and in an organized manner. The system provides a large variety of personally approved profiles to draw from. In contrast with long and boring questionnaires, the system may allow a parent to create a detailed profile for his son or daughter, in the format of a “scrapbook” or album or gallery or “feed”, allowing mothers to curate the best (in their view) of their kid's history, and providing a considered insight into their personality, background, values, and journey through life. The Applicants have realized that mothers have the emotional investment to keep searching, making the time to explore every avenue until they find a suitable match for their kids; mothers do not quit after a brief flurry of activity; rather, they persist until they succeed. Optionally, a “personal fairy godmother” module provides a photo optimization method, helping mothers choose the most highly effective photos to showcase on their kid's profile.

In some embodiments, the system may be provided to users for free, or for a fee. For example, a subscription-based system may be deployed, requiring the user (e.g., the parent) to pay a fee for a time-based subscription (e.g., weekly, or monthly, or yearly). Additionally or alternatively, fees may be charged on a per-search basis, or per-communication basis, or per-match basis. In some implementations, fees may be reduced or waived for certain types of users (e.g., a parent of a disabled person), or for users who meet pre-defined criteria (e.g., reduced fee for a user that uploaded at least three photographs of her son, or wrote at least 300 words about her daughter). In some implementations, optionally, a user (e.g., a mother) may pay a premium fee in order to promote her child's profile; for example, if the mother of Eve searches for a male candidate for Even in Brooklyn, and there are 200 such candidates who are typically sorted based on freshness (e.g., newest profile is shown first), the profile of candidate Adam may be shown at the top since his mother had paid a premium fee to advance his placement (e.g., payment of six dollars, to secure top placement in search results across 100 searches that include Adam in their results). Other monetization mechanisms may be used.

In some embodiments, the system may comprise, or may interface with, a payment system that enables collection and/or distribution of money, including real-world money (e.g., paid to the system administrator via credit card, debit card, wire transfer, or the like) and/or virtual money or crypto-currency assets (e.g., Bitcoin, Ethereum, or the like). For example, the mother of Adam and/or the mother of Eve, who take part in the match-making of Adam with Eve, may optionally purchase through the system a gift card with a credit balance of $50 to a particular restaurant or establishment (e.g., coffee shop, theater, museum, or the like) or other venue; and the system may automatically send the gift card (or other incentive, such as a discount coupon) to the child or children involved (e.g., to Adam, or to Eve, or to both of them), as an incentive to proceed with their matching process “at the expense” of the mother(s) who initiated it. In some embodiments, optionally, the gift card or other incentive may have a pre-defined expiration date (e.g., 7 or 30 days), such that if the two candidates (or one of them) did not utilize the gift card within a pre-defined time period, then the gift card is canceled and its value (in whole, or in part) is paid back to the sponsoring mother(s), or, is automatically canceled and a new gift-card is generated as is sent to the sponsoring mother(s) only and not to the child or children.

In some embodiments, the system may further enable to establish a community of mothers (or parents; or other family members of the matching candidates, such as grandmother, grandfather, aunt, uncle, cousin or the like) discussing their grown-up kids' (or other family members, or friends) relationship potential; optionally in conjunction with organizing local events, networking events for mothers or parents, an online forum to exchange information, an online magazine, and other services. Such online community and information exchange may be particularly suitable for “empty nesters”, or parents whose children are now grown-ups or adults and/or have left the home residence of the parents. The online community of parents may operate and exchange messages and information, in a unique manner that fulfills a match-making potential that was not tapped before by conventional match-making systems or by conventional online community tools (e.g., online blog, online Facebook group).

For example, the online tools and the unique application or “app” of the present invention, may allow Mother 1 to suggest to Mother 2, that Son 1 of Mother 1 may be a potential match for Daughter 2 of Mother 2; and may enable the two mothers to correspond and to push forward that match-making, before the two candidates (Son 1 and Daughter 2) know of each other; and may further enable Mother 1 and/or Mother 2 to receive from the system rewards or awards or prizes or other incentives for every Match that succeeds, and/or for every Match that is proposed and/or accepted by another parent and/or by a candidate for matching, and/or for a particular Milestone Progress in the matching progress (e.g., Mother 1 gets a reward if Son 1 and Daughter 2 actually exchange two online messages between them, or go out to a real-life meeting and confirm so to the system, or the like).

In some embodiments, the system may uniquely enable a “chain” of match-making steps that involve multiple parents and/or multiple children (sons, daughters) and optionally third parties. In a first example, continuing from the above-mentioned scenario, Mother 2 receives the online proposal of Mother 1, who suggested to match between Son 1 (of Mother 1) with Daughter 2 (of Mother 2); then, Mother 2 shows to Daughter 2 the profile or other data about the candidate Son 1, such as, by forwarding to the daughter a link to his profile on the system (e.g., a profile of Son 1 that Mother 1 had created for him and about him, sometimes without yet the knowledge of Son 1 that such profile was created and populated with data; or, a profile of Son 1 on another social networking website; or, a personal or professional “resume” of Son 1, or a photo or video of Son 1, or the like); then, Daughter 2 may provide feedback to her mother (Mother 2), indicating that Daughter 2 is not interested in Son 1 whose main hobby is football, yet also indicating that perhaps her friend, Daughter 3, who likes football a lot may be interested in matching with Son 1 of Mother 1. Upon such feedback to the system from Daughter 2, one or more steps may be performed: for example, Daughter 2 may provide to her mother (Mother 2) a link or pointer or other indicator associated with her friend (Daughter 3), and/or a similar link or pointer or indicator associated with the Mother of that friend (namely, with Mother 3 who is the mother of Daughter 3), and Mother 2 may proceed to suggest the match candidate (Son 1) to that Daughter 3 and/or to her mother (Mother 3). Additionally or alternatively, the feedback from Daughter 2 may be sent or provided, directly or indirectly, to Mother 1 of Son 1, so that she—who was the original initiator of the proposed match—would continue to handle the match-making and would contact directly Mother 3 and/or Daughter 3. Additionally or alternatively, the feedback from Daughter 2 may be sent or provided from Daughter 2 to her friend, Daughter 3; and/or to Mother 3 who is the mother of Daughter 3, in order for such recipients to explore the possibility of matching between Son 1 and Daughter 3. In some embodiments, a reward or incentive may be provided to each one of the involved parties or to some of them or to one of them (e.g., the match initiator Mother 1; the match responding parent Mother 2; the “link(s)” in the chain of matching, such as Daughter 2; and the match candidate themselves, such as Son 1 and/or Daughter 2 and/or daughter 3), for every step that they perform along the match-making process, or for some particular step(s) that they perform, or for a particular milestone progress in the process (e.g., the two candidates have securely or privately exchanged at least N messages through the system).

In some embodiments, an initiating mother (Mother 1), or a responding mother (Mother 2), or both of them, may optionally refer the potential match-making data to a third-party Advisor, prior to triggering the actual online connection between the matching candidates (Son 1 and Daughter 2), or after triggering it or in parallel to triggering it; for the purpose of obtaining from such Advisor his or her input with regard to the potential success of such proposed match. The Advisor may be, for example, an expert or professional match-maker; a spiritual or religions leader (e.g., a priest a rabbi, or the like); a celebrity; a person known in the community for having useful advice; an advisor that utilizes one or more fields or skills or knowledge to advise regarding success or failure or other consequences (e.g., an advisor that utilizes astrology, numerology, tarot, cards, horoscope, psychologies, social networking expert, a Kabbalah expert or advisor, or the like); and such Advisor may review the profiles of the two candidates, and/or other data about them (e.g., birth of date, time of date, place of birth, current geographic location, current age, current profession, current interests and hobbies, or the like), and may provide via the system a particular advice, to Mother 1 and/or to Mother 2, regarding the potential success or failure of such match-making, and/or regarding other parameters that Mother 1 and/or Mother 2 may find useful (e.g., a particular calendar date in which the match-making should preferable be performed, or not performed, in order to better succeed). It is noted that it may not necessarily be relevant whether both mothers (Mother 1 and Mother 2) and/or the matching candidates (Son 1 and Daughter 2) fully believe in the correctness of advice of such Advisor, and/or fully embrace it or adopt it or follow it; and it may suffice, in some implementation, that at least one person involved in the match-making process (e.g., Mother 1) finds such advice useful or helpful or comforting or persuading for herself, and accordingly, in some implementations, such third-party Advisor feedback may be provided, securely and privately, only to one or some of the involved parties (e.g., only to Mother 1), without necessarily being exposed to other parties involved in the match-making process; and/or may be provided to Mother 1 at a particular pre-defined time-point (e.g., before Mother 1 makes any initial approach or proposal to Mother 2; or, before Mother 1 and Mother 2 agree to connect between Son 1 and Daughter 2). In some embodiments, a party to the process (e.g., Mother 1) may be required or requested by the system to pay a fee to such Advisor, as a condition for receiving such advice; and/or may be required or requested by the system to “spend” or to give-out some of the virtual awards that she has already accumulated from previous activities on the platform (e.g., to give “one virtual coin” or “one star”, to such Advisor, out of the several stars or coins that Mother 1 had already earned through the platform; and such stars or coins may optionally be exchanged by the Advisor for real-life currency or prizes or rewards). In some embodiments, a ranking or scoring mechanism may enable mothers, parents, and/or match candidates, or other parties involved in the match-making process, to provide a score or ranking that would be associated by the system with a particular Advisor and/or with the correctness or usefulness of the Advice provide by him; and such score or ranking may optionally be viewed by other match-making parties.

The discussion herein, as well as the accompanying drawings or some of them, may present operations and/or screens and/or UI elements and/or GUI elements, which may be utilized by some implementations of the system and method of the present invention. In some embodiments, optionally, the following operations and/or screens may be used, additionally or alternatively, or in combination with the other elements or screens that are described herein and/or depicted in any of the drawing. For example, screen #1 may present a “splash screen” or welcome message. Screen #2 may convey to the user that this platform is, first and foremost, a platform for a community of women (e.g., parents of grown-up children; or “empty nesters”) having a shared goal, to help their children be as happy as can be, and/or to find a suitable match candidate for their children; and may further request the user to accept “terms of service”. Screen #3 may enable the user to input her user-name (or email address) and password, or other log-in credential or user-authentication credentials that are unique to her and/or that are known only to her. Screen #4 may convey to the user a reminder that moms are not more and more technology-oriented, while their adult children are now busier, which provides an opportunity for moms to help their adult children in match-making Screen #5 may enable the mother to choose or modify or edit her Avatar, and enables her to provide details about herself (e.g., being alumni if a particular school or college or university; having a particular profession or occupation; belonging to a particular type or group of parents; or the like). Screen #6 may enable the mother to start creating a separate (yet linked, or associated) profile about her grown-up child; by providing the child's name, occupation, matching preferences (e.g., which gender(s) the child prefers to match with), the child's age, or the like. Screen #7, or a pop-up or insert in a previous screen, may introduce a message from the “fairy godmother” as provided by the system or through the system, conveying to the mother that the system is here to help the mother find the best match for her adult child. Screen #8 may enable the mother to provide or upload to the system, one or more photos and/or videos of her candidate child; for example, uploading directly from her phone or tablet, importing from a cloud-based repository of files or images, importing from a social networking website or profile of the mother and/or of the son or daughter, or the like. Screen #9 may enable the mother to command an import of the child's data from the child's social network profile or page, or from other third-party source or repository; and/or may enable the mother to request that a collage of photos would be automatically prepared by the system from such sources and/or photos. Screen #10 may enable the mother to select characteristics of her child from a pre-defined list (e.g., optimistic, creative, impatient, confident, self-centered, or the like), and/or to enter other or additional character traits as free-text, and/or to enter a free-text that describes the child or a special story or anecdote about the child. Screen #11 may enable the mother to define or select or otherwise provide to the system, additional data about the child; such as, the child's geographic location, profession or occupation, belonging to a sorority or fraternity, belonging or being alumni of a school, ethnicity data, religion data (e.g., religion observed by the child, and the level of such observing), height, weight, astrology information (e.g., zodiac sign; or exact date and time of birth and birth location from which the system may determine the zodiac sign or other astrological data), or the like. Screen #12 may enable the mother to review the profile that she has just created regarding her child, and to further edit or modify it; and to optionally share it right away with other third parties of her choice. Screen #13 may enable the mother to similarly create additional profile(s) about other child or children of her; and to manage or edit or modify such profile(s) from a central location in the App or the Website; and to select to initiate a match-making process for a particular one of her children. Screen #15 may enable the mother to perform a search for profiles of other mothers (or parents) and/or other parent's children in the system, based on one or more search criteria; for example, based on geographic location (e.g., distance from a particular city or zip-code; or being located within a particular city or zip-code), based on character traits or personal data parameters of the matching candidates (e.g., “show me only Girls, who are in the age range of 25 to 35 years, who live in Boston, and who have character traits ‘confident’ and ‘ambitious’ in their profile); and to review search results. In some embodiments, optionally, the search functionality may be able to perform a search based on analysis of a free-text query entered by the mother; for example, the mother may type “girl Boston 25 confident”, and the system may automatically interpret such query as (or, convert it automatically into) a query for girls located in Boston and having a character trait of ‘confident’ and being at the age of 25 years old (or, being in the age range of 25 years plus-or-minus three years). Screen #16 may allow the mother to browse, view and/or select one or more of such profiles, and to mark or bookmark or tag them as “interesting” or as “potential match” for her own child; and to send a copy of the other child's profile (or at least a portion thereof) to her own child for his (or her) consideration, together with an accompanying message (e.g., “Hi my son, please see the profile or photo of this cute girl Melanie, who is the daughter of my best friend Linda; would you like the contact details of Melanie?”). Additionally or alternatively, the mother who performed the search, may send a secure or private message to the mother (or parent) of the candidate Melanie, who had created that profile; and/or may even send a direct private message to Melanie herself. The system may then enable the searching mother to continue with browsing the search results, and/or to perform other searches, and/or to communicate with other match-candidates and/or with their parent(s) via the system. Screen #17 may enable the mother to view a plurality of match-candidates that the mother had previously viewed and tagged as interesting, and/or that the mother had already contacted (them, or their parents); and to view the current progress of those previous communications or actions (e.g., a current status of “You have sent this profile to your son John on April 15, and he did not yet respond”; or, a current status of “You have sent to your friend Linda, the proposal to match between her daughter Melanie and your son John; and Linda has responded positively on April 18; and John had communicated with Melanie on April 21”; or the like). The system may further enable a mother to view various profiles, based on whether or not they were acted upon, or were already proposed as a match to her child, or were already tagged by the mother as “favorite” or “interesting”; or based on other criteria. For example, the mother may command the system to filter or sort the profiles that she had already tagged as “interesting”, and to show to her now only those profiles that have the character traits of “confident”; and the system may accordingly filter or sort the list, and show only the relevant profiles at this stage. Screen #19 may enable the mother to securely and privately and discretely communicate (e.g., via a messaging functionality) with the mother (or parent) of the match-candidate, in order to provide and/or receive updates or information about the progress of the match-making process, or its success or failure or current status. Screen #20 may enable the mother to view a list of messaging parties, with whom she had messaged before, thereby allowing the mother to view in a central location the previous threads of communications with other mothers and/or with other match-candidates; with the option to command the system to show only communications threads with other parents, or to show only communication threads with match-candidates (children of other parents). Screen #21 may enable the mother to create and/or modify and/or edit her own profile and/or the profiles of her children, and/or the avatars or photo(s) associated with herself and/or with her children. Optionally, a “Scrapbook” tool or screen or interface may enable a mother to upload or import or otherwise provide a series or a set of photos of her child, which she may then further edit (e.g., crop, shrink, enlarge), and/or which she may then request from the system to automatically generate from them a collage or an animated clip or other modified output. Screen #22 may present to the mother the progress of various tasks or processes that she initiated or performed, as well as the rewards that were already earned for them, and/or the remaining actions to be performed by her in order to gain additional rewards; for example, indicating to the mother that: (i) she has initiated three proposals addressed to other mothers, thereby earning 6 stars; (ii) she has responded positively to a proposal received from another mother, thereby earning 2 stars; (iii) she has communicated via chat with five other mothers, thereby earning 5 stars; or the like. Screen #23 may enable the mother to request advice from a third-party Advisor, regarding a potential success of a particular match for her child. Screen #24 may enable a mother to convert already-gained stars or points or rewards, into a particular real-life reward or prize; or to share or transfer such stars or points with another person (e.g., with her own husband, who may have his own parent account on the platform). Screen #25 may enable the mother to purchase a real-life reward or prize, such as a gift certificate to a coffeeshop or to a movie theater, that will be provided by the system to her child if her child responds positively to a particular match suggestion; thereby enabling the mother to financially sponsor or to financially support or facilitate the real-life meeting of her child with a particular candidate; or thereby enabling the mother to direct the proposed meeting towards a particular real-life activity (e.g., the son and the other girl both have interest in Bowling; therefore the initiating mother, or the accepting mother, purchases and provides to them a gift certificate to a local Bowling venue). Other suitable screens or operations or flows may be used.

In a demonstrative embodiment, a system for match-making or matching among users or among profiles of users, may comprise multiple units or modules. For example, an Account Sign-Up module may handle new registrations (e.g., by mothers, or parents); optionally utilizing a third-party authentication system (e.g., “log-in via your Facebook credentials”) to facilitate or speed-up the process. A Profile Creation module allows the mother to create a profile for the child; indicating, for example, first name, last name (e.g., would be hidden from third parties), photos, videos, gender, age, height, geographical location, education level or details, occupation, hobbies, ethnicity, marital status (e.g., single, divorced), other free-text information (e.g., an interesting fact or anecdote about the child); and optionally, one or more link(s) to social media page(s) of the child (e.g., his or her Facebook page, Instagram page, Pinterest page, LinkedIn page, or the like). A Matching Preferences module allows the mother to indicate the properties for a good match or a suitable match for her child; such as, age or age-range, gender (e.g., female seeking male, female seeking female), geographic location (e.g., within a particular state, or within K miles of a particular town or zip code), desired education level (e.g., at least high-school diploma; at least bachelor's degree), and/or other properties.

In some embodiments, optionally, a Cyber Verification Module or Cyber Authentication Module or other (e.g., triangular or multi-point) Relationship Verification/Authentication Module or Parent-Child Relationship Validator Module, may be used by the system (e.g., autonomously, or automatically, or at least semi-automatically), in order to ensure that the person who claims to be Adam's mother is indeed Adam's mother. For example, the module may match between the name of the child, the link provided to the Facebook (or other social media) page of the child, and checking that the child is indeed in a friend's list of the mother (e.g., on her Facebook profile). Optionally, the module may require the user who claims to be Adam's mother to prove such relationship via suitable documents; for example, requiring a user to upload or submit a photo of her driver license and/or of the child's driver license (or other government-issued identification card or document), and/or a copy of the birth certificate of the child (e.g., in which the mother is named), in order to prove mother and son relationship. In some implementations, the module may access and/or utilize public records or public databases or private databases (e.g., birth records, marriage records, credit reports, legal records, criminal records, school records, university or college records, or the like), optionally after obtaining the consent of the parent and/or the child involved, in order to verify or authenticate the claimed relationship between them, and in order to reduce or prevent fraud or abuse of the system.

A Data Editor module may allow user(s) to edit the profile, or to delete a profile; and may further indicate who exactly is authorized to edit or delete the profile (e.g., the mother, the child, any of them, both of them).

A Potential Matches Generator may scan or search the database of profiles, and may detect already-existing profiles that match the Matching Preferences that were recently entered by the mother; and optionally, may show to the mother, still during the account creation process, an initial list of N candidates (e.g., 5 or 10 candidates), showing only their first name, photo, and age, location, and/or education level; and allowing the mother to see the full profile of the candidate upon completing the registration process. When a mother sees a profile of a candidate, multiple GUI elements may enable her to engage with various call-to-action options; such as, “initiate contact” in order to contact that candidate and/or his parent; “block/discard” to indicate to the system that this particular candidate is not of interest to this mother and thus should not appear again in future search results or in future matching suggestions; “recommend” to another mother (or to another parent) to review this particular candidate for her own child; “favorite” or “think about it”, to add the candidate to a list of “favorites” or to a list of candidates for further review later by the mother; “share” to share the profile, or a link to the profile, or a partial data-set of the profile information, with a third-party; and/or other actions.

An Interested Parties module may show to the mother a list of candidates, or mothers (or parents), that had already indicated their interest in matching with the child of that mother; and their respective offers or proposals or requests to match. The mother may select to “decline”, and then a negative notification is sent to the interested party, and the declined candidate is removed from the “interested parties” list, or is moved from that list to a list of “already declined parties”). Alternatively, the mother may select to “accept” the invitation to match; and a positive notification may be sent to the other mother (or parent) who initiated the contact, and/or to the candidates (the sons/daughters) of these two mothers. Upon an accepted match proposal, optionally, the full name of each candidate and/or his (or her) social network profile are revealed to the mother(s) involved, who may then share the information with their offspring.

For example, the mother of Adam fills-out a profile regarding Adam; and the mother of Even fills-out a profile regarding Even. Each one of these mothers fills-out the matching preferences for their kids. The system determines that Adam complies with the matching preferences that were indicated by the mother of Eve, and the system indicates so to the mother of Eve. The mother of Eve reviews the profile of Adam; optionally, without knowing yet his Facebook (or social media) page or profile, or alternatively, together with being notified by the system of his Facebook (or social media) page or profile. The mother of Eve decides and indicates to the system that Adam is a suitable candidate for Eve. The system sends a notification to the mother of Adam, indicating that the mother of Eve thinks that Adam and Eve may be a good match; and enabling the mother of Eve to view the partial or the full profile of Eve in the system, and optionally to view also the Facebook (or other social media) page or profile of Eve. The mother of Adam reviews the data about Eve. If the mother of Adam agrees that Adam and Eve may be a good match, then the mother of Adam indicates so to the system; which now has Double Approval from the two mothers. From this point onward, one or more operations may be performed; for example, a message may be sent to both mothers, with the full data about each child (e.g., if only partial data was exposed before); and/or a message may be sent to Adam and Eve with full or partial data about the other candidate; and/or a message may be sent to only one of the two candidates (e.g., only to Eve since her mother made the first move; or, only to Adam since his mother was the accepting mother and not the choosing mother; or, only to Adam since the system defines males as first-movers; or, only to Eve as the system defines females as first-movers), the message indicating partial of full profile data and/or the link to the Facebook (or other social media) page of the other candidate. Optionally, the system enables secure or private communications between the parties (e.g., between the mothers; between Adam and Eve), through an on-line messaging system or via an in-app messaging system that enables users to exchange messages through the central server of the system and without requiring any user to expose his or her telephone number, email address, or other contact data.

Optionally, each one of the candidates (Adam, Eve) may later update the system with regard to the success or failure of the suggested match; and the system may send notifications to the mothers involved; such as, “Adam declined to proceed”, or “Eve declined to proceed”, or “Adam and Eve proceeded to communicate but then Adam indicated his desire to quit”, or “Adam and Eve proceeded to communicate but then Even indicated her desire to quit”. Accordingly, a Matched Parties module may monitor the progress of such match suggestion, and may enable each mother to see the progress or to receive notifications about it; in order to allow the mother to make new match suggestions. In some embodiments, optionally, the mother of Eve may not make a new match suggestion towards another mother, until at least N days passed (e.g., at least 3 days passed) since her previous match suggestion was sent to the mother of Adam, or, until at least K days passed (e.g., at least 5 days passed) since both Adam and Eve were contacted by the system about their mothers-approved match; thereby enforcing a short “exclusivity period” to give a real chance to the match process between them, and/or to prevent a mother from “flooding” numerous other mothers with matching requests, and/or to provide an increased security and reliability and seriousness to the process (e.g., requiring a mother to think twice before sending a match request, as she may be blocked form sending other match requests for 24 or 48 hours afterward). In some embodiments, optionally, even if the two mothers agree and indicate that Adam and Eve are a good match, the system may intentionally delay the communications to these users (Adam, Eve) since the system may already know that they have recently engaged in communication with a third-party due to a previous match suggestion. Other suitable mechanisms may be used to control the timing of communications among the relevant parties, to delay them or to speed them up.

In some embodiments, the system may utilize a queue for suggestions from the mother of Eve to Eve herself, in order to prevent flooding of Eve by communications from her mother; for example, allowing the mother of Eve to share with Eve only one suggested candidate every N days (e.g., every two days). The shared information may include a partial data-set from the profile of each candidate, and may optionally include a link to his Facebook (or other social media) page or profile.

Some embodiments may enable a mother to create and manage multiple profiles for her multiple children, and to manage them via a centralized dashboard. For example, the mother of Becky (age 19) and Rachel (age 21) may create one account as their mother, and may define two separate profiles for them; later, the system may match Jacob (age 25) as a candidate match for Rachel, and the mother of Rachel may contact the mother of Jacob to indicate her interest. The system may keep two separate “interested parties” lists, or two separate “matched parties” lists, to separately manage the match suggestions with regard to Rachel from those of Becky; for example, allowing their mother to log and monitor that Rachel was introduced to the mother of Jacob, while Becky was introduced to the mother of Joseph.

Optionally, an Invitations Module allows a mother to invite friends or third-parties to join the platform, via email or text message or instant messaging; optionally by utilizing a user-specific referral link that rewards the referring user if the target user indeed visits and/or joins the matching platform. The reward may be, for example, one or more “free match requests” in a system that collects a payment for a pre-defined list of match requests; or other suitable rewards or incentives. In some embodiments, virtual rewards may be used as incentives, allowing mothers (or parents) to compete on their “level” of performance/experience within the platform; for example, allowing a mother to collect points or to increment her level by successfully referring other users to visit the platform and/or to sign-up to the platform, allowing the mother to earn rewards or points for every match suggestion that was approved by another mother (or, that proceeded to yield at least K in-system communications between the two candidates), or the like.

In some embodiments, the mother of Adam and/or the mother of Eve, when they request or approve the match between Adam and Eve, may optionally suggest a particular idea or suggestion or other useful input; which may be brought to the attention of the other mother, and/or may be brought to the attention of Adam and/or Eve. For example, the mother of Adam may notice that each one of Adam and Eve has a hobby of “tennis”, and thus the mother of Adam may add a suggestion that Adam and Eve would meet for a friendly tennis game, or would meet by going together to watch a professional tennis match. In some embodiments, optionally, a contextual analysis module of the system, or a Natural Language Processing (NPL) module of the system, may automatically detect common hobbies or common interests of the two candidates (Adam and Eve), and may automatically suggest to them (or to the mother of Adam, or to the mother of Even, or only to Adam, or only to Eve, or to both of them) to engage in an activity that is connected to such common interest that was identified by the system.

In a demonstrative implantation, the system may provide various screens or GUI elements; for example: Onboarding, Find the right match, Make an offer, Communicate, Get a “place in heaven” (or other rewards system), Login/Signup, Create profile, List of matches, Matching preferences or criteria, View profiles/matches, Settings, Invite, Recommendations; a dashboard for monitoring previous match suggestions and their progress; and optionally, an electronic commerce module that allows a mother to pay for the service, or to pay for a subscription period or for a pre-defined number of matches, or the like.

The system may utilize one or more flows of operations, to initiate a match suggestion and/or to approve it, and/or to proceed with enabling communications based on such match suggestion and/or based on match approval. In a first demonstrative flow, the mother of Adam likes the profile of Eve that was created by the mother of Eve; and obtains the full details of Eve from the system without necessarily requesting or obtaining the consent of the mother of Eve; and the mother of Adam shares with Adam the full details or at least partial details of the profile of Eve; and Adam may then utilize the system (or an external communication means, such as Facebook or social media) to further communicate directly with Eve. This flow does was actually initiated by the mother of Eve who published the profile of Eve; but without the specific approval of the mother of Eve to proceed with the candidate Adam. This may provide a seamless and faster user experience; although Eve may not necessarily understand or know how or why Adam contacted her, unless Adam explains to her the previous actions (namely, that Eve's mother published a profile about Eve; and that Adam's mother saw that profile and recommended it to Adam).

In another demonstrative flow of operations, the mother of Adam likes the profile of Eve, and notifies to the system so; and the system notifies to the mother of Eve that the mother of Adam likes the profile of Eve; and only if the mother of Eve approves, then the system shares with Adam and/or with Eve the full contact details or each other, and/or enables direct (e.g., in-system, in-app) communications between Adam and Eve. This flow provides more control to mothers with regard to who can see or access the profiles of their kids.

In some embodiments, optionally, the system may utilize verification mechanism to ensure the truthfulness of data inputted to the system by users. For example, in some implementations, the system administrator may require mothers to upload copies of driver license, birth certificate, college diploma, and/or other documents that can authenticate one or more data-items about the child (e g, name, age, gender, level of education) and/or about the parental relationship.

In some embodiments, optionally, the system may require users (or, may suggest to users) to comply with a set of rules or terms, such as a “Ten Commandments” declaration of rules; and the system may optionally include mechanisms to monitor such compliance, to generate a “warning” to users who do not comply, and/or to take steps or actions against users that do not comply with such rules (e.g., account suspension; account deletion). In a demonstrative embodiment, such rules may be directed to the mother (or to parents, or to the match-making user), and may include, for example: (1) you shall not push potential suitors that

your kid is not interested in; (2) you shall listen to your kid; (3) you shall not push; (4) you shall not “snoop” or spy or meddle; (5) you shall not tag along; (6) you shall not get too serious; (7) you shall not get offended (e.g., if a match candidate is not interested in your kid); (8) you shall not gloat; (9) you shall encourage meeting-up (e.g., in person, and not merely online or by phone); (10) your shall help other mothers (or other parents, or other match-makers). Other suitable rules or terms-of-use may be used and/or enforced.

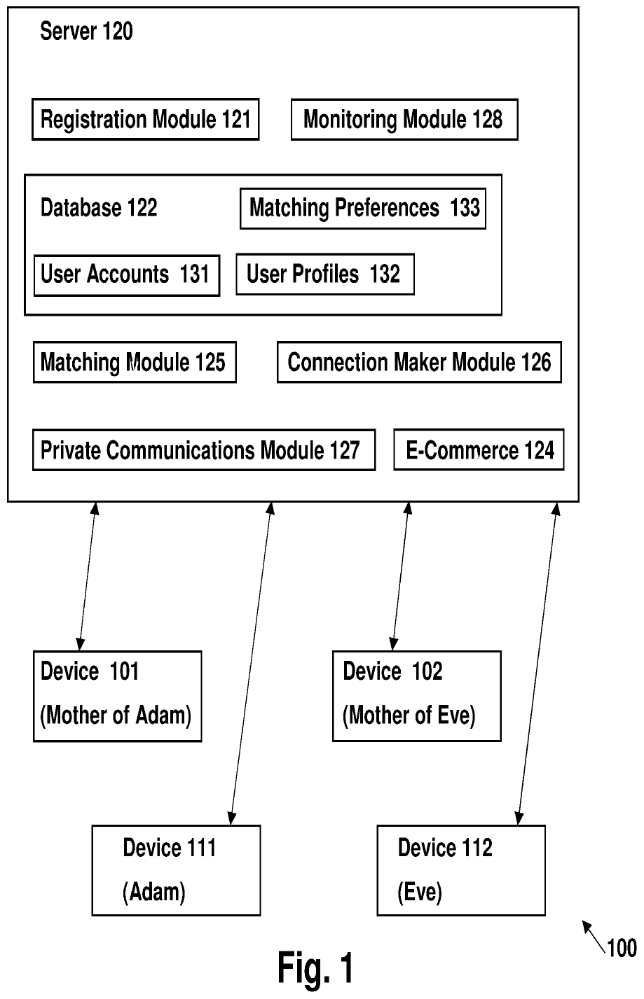

Reference is made to FIG. 1, which is a schematic illustration of a system 100, in accordance with some demonstrative embodiments of the present invention. System 100 may comprise a server computer 120 able to communicate over wired and/or wireless links with multiple users operating electronic devices (e.g., laptop computer, desktop computer, smartphone, tablet, smart-watch, or the like).

For example, device 101 may be a laptop computer operated by the mother of Adam; device 111 may be a smartphone operated by Adam; device 102 may be a tablet operated by the mother of Eve; and device 112 may be a desktop computer operated by Eve. Each one of devices 101-102 and 111-112 may utilize an application or an “app” or a web-browser, to access an online platform of the system and to interact with it.

In server 120, a registration module 121 allows the mother of Adam to register and create her own account; and similarly allows the mother of Eve to register and to create her own account. Each mother creates an online profile for her son or daughter. Data of user accounts 131, and data of user profiles 132, is stored in a database 122. Each mother also defines matching preferences 133 for her child, which are also stored in the database 122.

The mother of Adam requests the system 100 to suggest matches for her son Adam, based on the profile that she created about Adam, and based on profiles of other candidates in the database 122, and based on the matching preferences that were indicated for user Adam, and optionally also based on the matching preferences indicated by other candidates. A matching module 125 searches for candidate profiles that comply with these conditions, and presents a list of candidate matches to the mother of user Adam; one of those candidates includes the profile of Eve as created by the mother of Eve.

The mother of Adam indicates to the system that she thinks that Eve would be a good match for Adam; and a Connection Maker Module 126 sends a communication to the mother of Eve, notifying her that the mother of Adam believes so. The mother of Eve responds with an approval or a rejection. If the mother of Eve responds with a rejection, then the Connection Maker Module 126 notifies to the mother of Adam that the suggestion was declined; and, the database 122 is updated to reflect that the mother of Eve did not approve to match Eve with Adam (e.g., permanently, or for at least N days, such as for at least 90 days), such that Eve would not appear again as a suggested match when the mother of Adam searches for matches. Alternatively, if the mother of Eve responds with her approval, then the Connection Maker Module 126 notifies so to the mother of Adam, and proceeds to introduce Adam to Eve and/or Eve to Adam, via email, via text message, via instant messaging, or via in-app or in-system communications. Optionally, in response to such approval by the two mothers, a Private Communications Module 127 of the system enables secure and private communications between Adam and Eve, without requiring them to expose to each other their telephone numbers or their email addresses.

Optionally, a Monitoring Module 128 operates to monitor the communications among Adam, Eve and/or their mothers, and to send follow-up notifications or reminders to any of them or to some of them; for example, alerting them that one party did not respond to another party for more than N days, or that one party declined to further communicate, and so forth. Adam and/or Eve may indicate to the system that they do not wish to further proceed with this suggested match; and the system may update the database 122 to reflect so (e.g., permanently, or for a period of N days), such that Adam will not appear as a suggested match when the mother of Eve queries the system for potential matches to Eve, and/or such that Eve will not appear as a suggested match when the mother of Adam queries the system for potential matches to Adam.

Optionally, a Sufficient Similarity Detector 129 may operate to enable matches even if two candidates do not fully comply with the matching preferences that were defined for them by their mothers, but are “sufficiently close” based on a pre-defined threshold value, or based on parameters being within a range of values. For example, the mother of Adam may define that Adam is interested in females that are in the age range of 20 to 30 years, and in the height of 155 to 175 centimeters. The Sufficient Similarity Detector 129 may determine to include Eve in the list of potential matches shown to the mother of Adam, even though Eve is 19 years old or is 32 years old (e.g., as these values are within 10 percent of the age-range boundary, or within K percent of such value), or even though Eve is 177 centimeters tall, and so forth. Optionally, each mother may define the level of tolerance that may be applied to the matching preferences that she defined, thereby indicating to the system how flexible to be with regard to inclusion or exclusion of similar search results that do not fully comply with the desired matching properties but appear to be sufficiently close to them.

Optionally, an electronic commerce (e-commerce) module 124 may control monetary aspects of the operations of system 100; for example, collecting payment from users in order to create an account and/or a profile, or to perform a search for matches, and/or to initiate a communication towards another user; or to collect payments on a per-event basis, or on a time-period basis (e.g., monthly subscription); or to collect payments for premium features (e.g., advance your child in the ranking of search results, or display him with bold text or in yellow marker).

A method in accordance with some embodiments may comprise the following operations. First User (mother of Adam) creates an online profile regarding Second User (Adam), as well as matching preferences. Similarly, Third User (mother of Eve) creates an online profile regarding Fourth User (Eve), as well as matching preferences. First User (mother of Adam) requests from the system to find profiles of users that comply (exactly, or beyond a sufficient similarity threshold value) with the matching preferences that she had defined. The system notifies First User (mother of Adam) that Fourth User (Eve) is a suitable candidate, and allows First User (mother of Adam) to view the profile of Fourth User (Eve).

If First User (mother of Adam) determines that Fourth User (Eve) would be a good match to Second User (Adam), then: First User (mother of Adam) indicates so to the system; and the system sends a notification to Third User (mother of Eve), conveying to Third User (mother of Eve) that the First User (mother of Adam) thinks that Second User (Adam) is a suitable match for Fourth User (Eve), and enabling the Third User (mother of Eve) to view the profile of the Second user (Adam) as created by the First User (mother of Adam). If the Third User (mother of Eve) also thinks so, and indicates so to the system, then the First User (mother of Adam) and the Third user (mother of Eve) have both approved that the Second and Fourth users (Adam and Eve) would be a good match, and the system proceeds to notify so to the Second User (Adam) and/or to the Fourth User (Eve), and/or proceeds to enable private communications between Second User (Adam) and Fourth User (Eve) such that those communications are not exposed to First User (mother of Adam) and/or Third User (mother of Eve). Alternatively, if Third User (mother of Eve) thinks that Second User (Adam) would not be a good match to Fourth User (Eve), then Third User (mother of Eve) indicates so to the system, which in turn notifies the First User (mother of Adam) that the suggested match was rejected by the Third User (mother of Eve); and, the system updates its database to reflect that the Second User (Adam) and the Fourth User (Eve) should not be suggested again as a match, permanently or for at least N days, if the First User (mother of Adam) searches for suitable matches for Second User (Adam), or if Third User (mother of Eve) searches for suitable matches for Fourth User (Eve).

Similarly, if First User (mother of Adam) sees the search results that include the profile of Fourth User (Eve), and thinks that Fourth User (Eve) does not appear to be a good match for Second User (Adam), then First User (mother of Adam) indicates so to the system; and the system updates its database to reflect that the Second User (Adam) and the Fourth User (Eve) should not be suggested again as a match, permanently or for at least N days, if the First User (mother of Adam) searches for suitable matches for Second User (Adam), or if Third User (mother of Eve) searches for suitable matches for Fourth User (Eve).

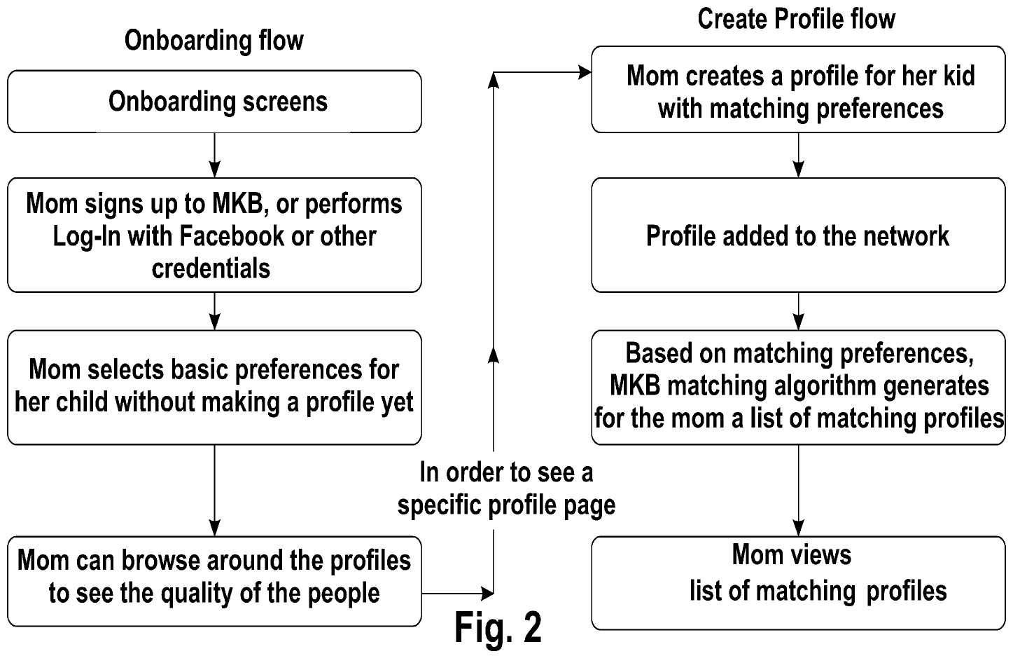

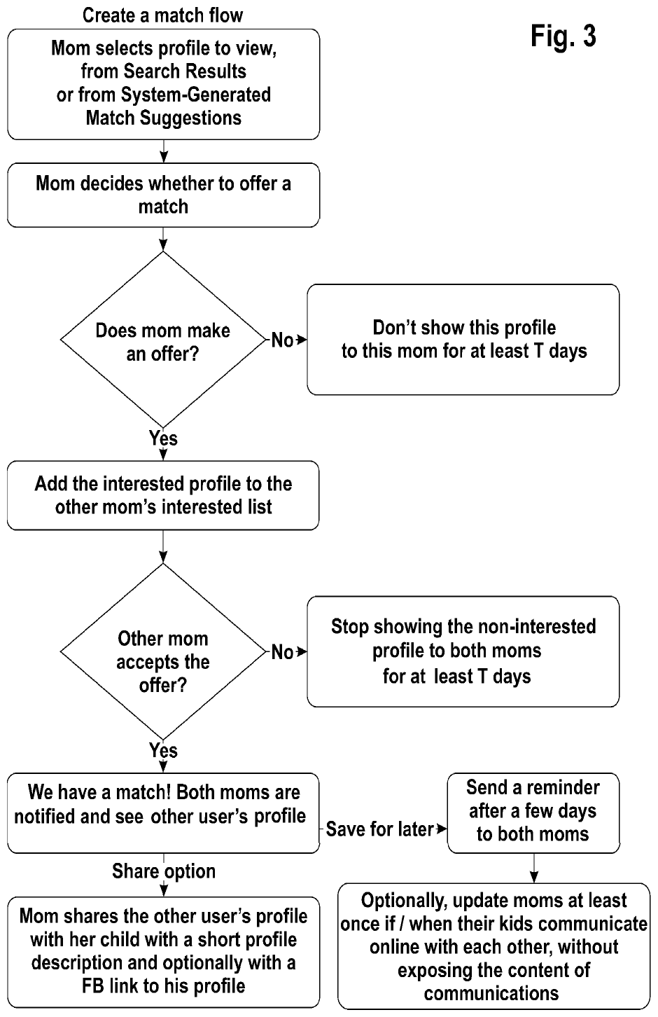

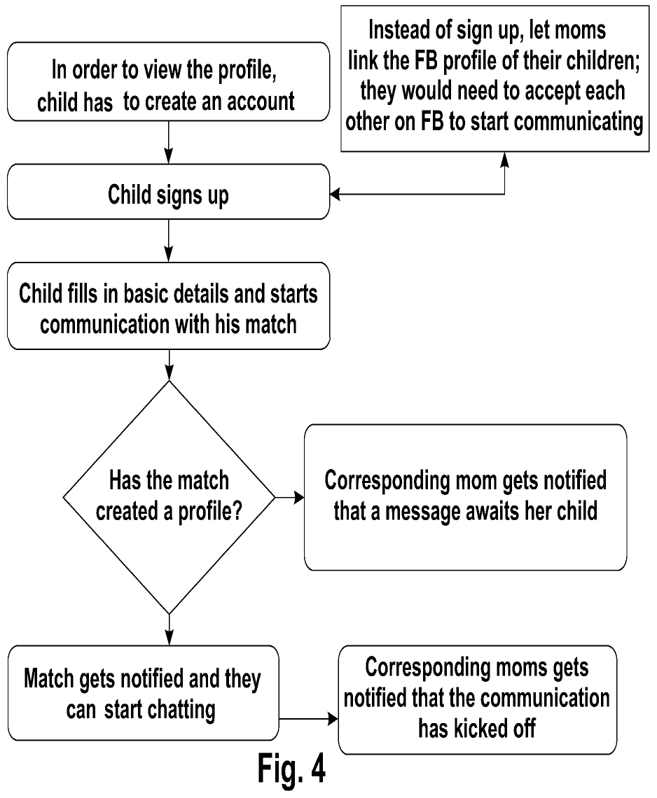

Reference is made to FIG. 2, which is a flow-chart of a method demonstrating an “onboarding flow” and a “create profile flow”, in accordance with some demonstrative embodiments of the present invention; and to FIG. 3, which is a flow-chart of a method demonstrating a “create a match flow”, in accordance with some demonstrative embodiments of the present invention; and to FIG. 4, which is a flow-chart of a method demonstrating a flow of operations performed by the child or offspring (the match candidate, or the match target), in accordance with some demonstrative embodiments of the present invention. In some embodiments or drawings, the system may be referred to as “MKB” or “the MKB system” or “the MKB network”, whereas MKB denoted “Mama Knows Best” or “Mother Knows Best”.

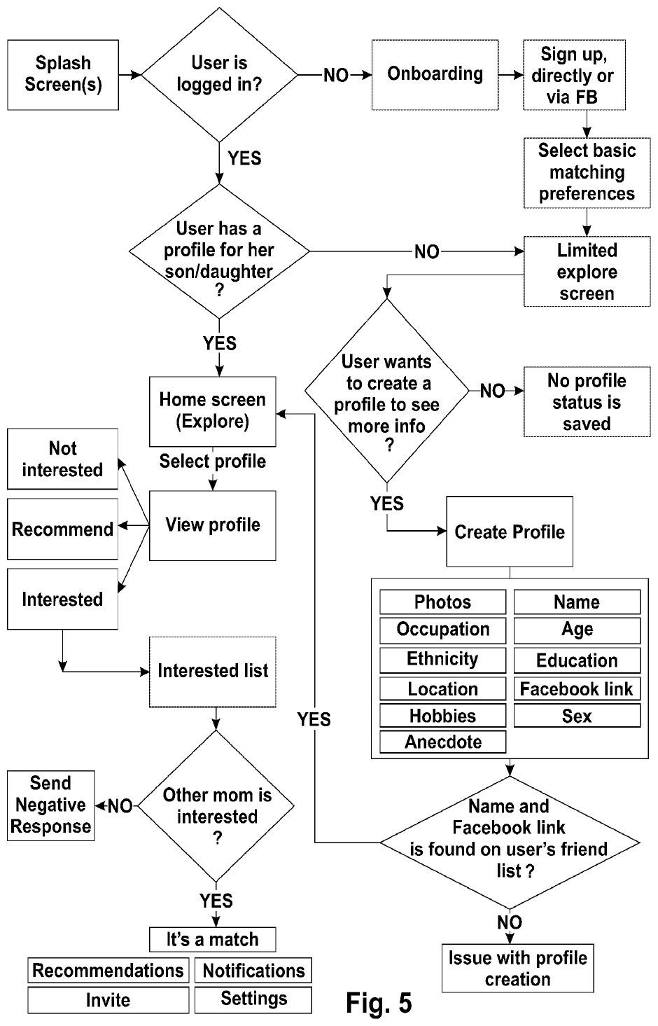

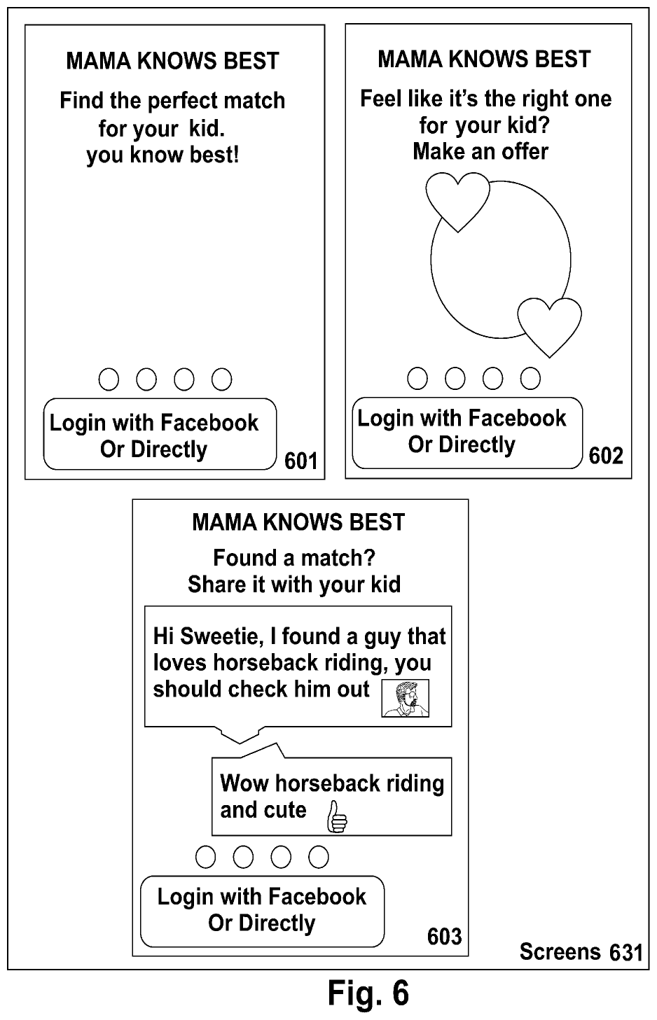

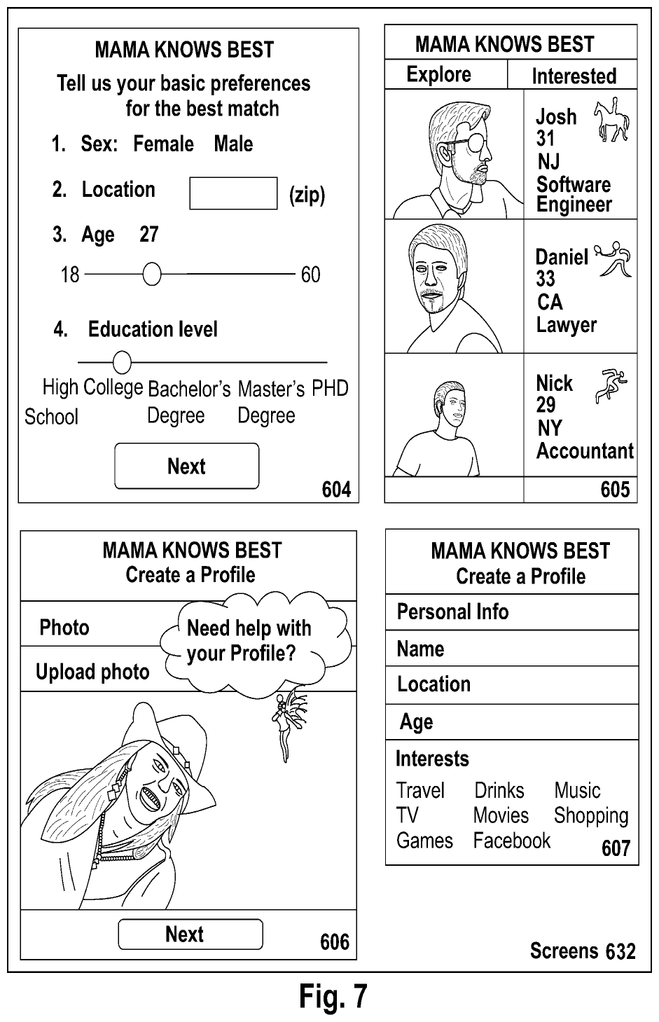

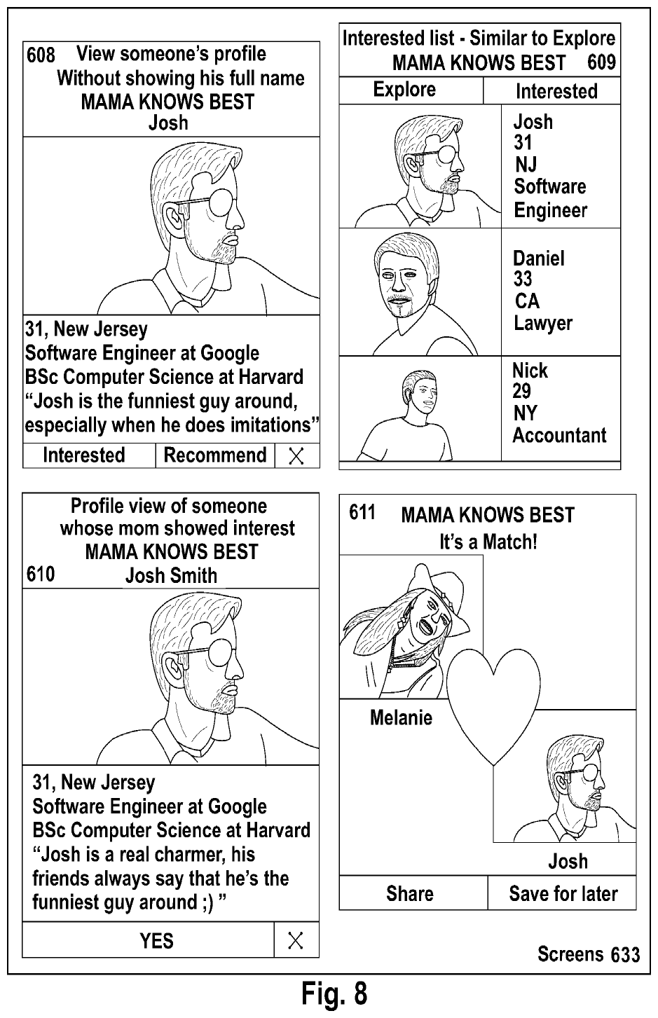

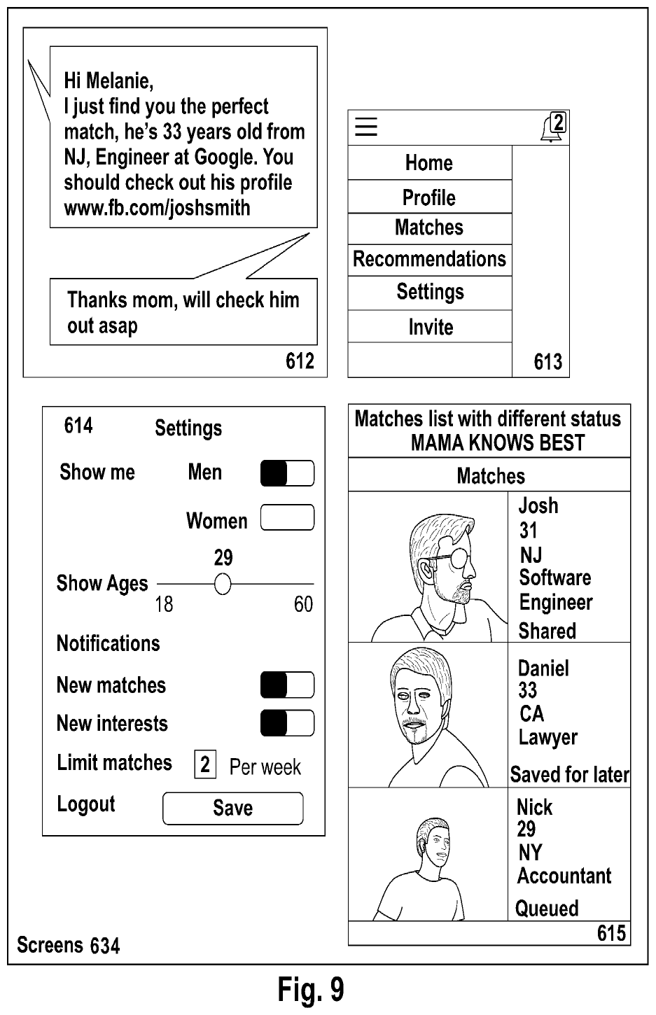

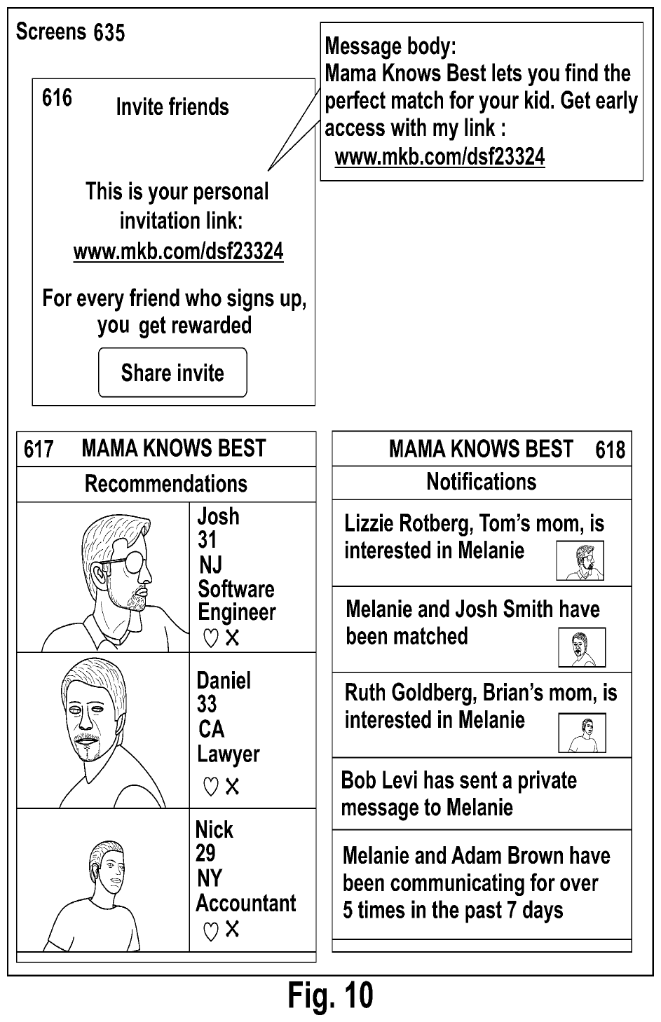

Reference is also made to FIG. 5, which is a flow-chart demonstrating a flow of screens or operations in accordance with some embodiments of the invention; as well as to FIGS. 6-10, which are schematic illustrations of sets of screens 631-635 which comprise screens 601-618 demonstrating GUI, interactions, input and output in accordance with some demonstrative embodiments of the present invention. Other suitable screens or GUI elements may be used.

In some implementations, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some implementations are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some implementations may utilize a special-purpose machine or a specific-purpose device that is not a generic computer, or may use a non-generic computer or a non-general computer or machine. Such system or device may utilize or may comprise one or more components or units or modules that are not part of a “generic computer” and that are not part of a “general purpose computer”, for example, cellular transceiver, cellular transmitter, cellular receiver, GPS unit, location-determining unit, accelerometer(s), gyroscope(s), device-orientation detectors or sensors, device-positioning detectors or sensors, or the like.

Some implementations may utilize an automated method or automated process, or a machine-implemented method or process, or as a semi-automated or partially-automated method or process, or as a set of steps or operations which may be executed or performed by a computer or machine or system or other device.

Some implementations may utilize code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), Register-Transfer Level (RTL), BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some implementations may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some implementations may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some implementations may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

In some embodiments, a method comprises: (a) creating a first supervisory account, having a first pair of username and password, for a first entity which is a first Supervisor Entity; (b) creating a second supervisory account, having a second pair of username and password, for a second entity which is a second Supervisor Entity; (c) creating a first target account, having a third pair of username and password, for a third entity which is a first Target Entity; (d) creating a second target account, having a fourth pair of username and password, for a fourth entity which is a second Target Entity; (e) creating an association between (I) the first supervisory account of the first supervisory entity, and (II) the first target account of the first target entity; (f) creating an association between (I) the second supervisory account of the second supervisory entity, and (II) the second target account of the second target entity; (g) receiving from at least one of: (i) the first supervisory account of the first supervisory entity, and (ii) the second supervisory account of the second supervisory entity, a request to create a communication connection between (I) the first target account of the first target entity and (II) the second target account of the second target entity; (h) based on said request, creating said communication connection between (I) the first target account of the first target entity and (II) the second target account of the second target entity.

In some embodiments, the creating of step (h) is performed only if said request is approved by both of the first supervisory entity and the second supervisory entity.

In some embodiments, the creating of step (h) is performed only if said request is approved by (i) the first supervisory entity and (ii) the second supervisory entity and (iii) at least one of the first and second target entities.

In some embodiments, the creating of step (h) is performed only if said request is approved by (i) the first supervisory entity and (ii) the second supervisory entity and (iii) the first target entity and (iv) the second target entity.

In some embodiments, step (h) comprises: creating a private communication connection between (I) the first target account of the first target entity and (II) the second target account of the second target entity; wherein content of communications performed via said private communication connection are not accessible by the first supervising entity and are not accessible by the second supervising entity.

In some embodiments, step (h) comprises: creating a private communication connection between (I) the first target account of the first target entity and (II) the second target account of the second target entity; wherein content of communications performed via said private communication connection are not accessible by the first supervising entity and are not accessible by the second supervising entity; providing an indication, to at least one of the first supervising entity the second supervising entity, that a communication session took place via said private communication connection between (I) the first target account of the first target entity and (II) the second target account of the second target entity, while preventing the first and the second supervising entities from accessing the content of said communication session.

In some embodiments, the method comprises: enabling the first supervising entity to perform search queries through a database storing profiles of target entities; providing to the first supervising entity a search result which comprises at least the profile of said second target entity; providing to the first supervising entity an indication that the second target entity is associated with the second supervisory entity; enabling a private communication session between the first supervisory entity and the second supervisory entity.

In some embodiments, the method comprises: enabling the first supervising entity to perform search queries through a database storing profiles of supervisory entities; providing to the first supervising entity a search result which comprises at least the profile of said second supervisory entity; providing to the first supervising entity an indication that the second supervisory entity is associated with the second target entity; providing to the first supervising entity access to the profile of the second target entity; enabling a private communication session between the first supervisory entity and the second supervisory entity.

In some embodiments, the method comprises: enabling the first supervising entity to perform search queries through a database which stores profiles of supervisory entities and profiles of target entities; providing to the first supervising entity a search result which comprises at least (i) the profile of said second supervisory entity, and (ii) the profile of said second target entity, and (iii) an indication about the type of association that exists between the second supervisory entity and the second target entity; providing to the first supervising entity (i) access to the profile of the second target entity, and (ii) access to the profile of the second supervisory entity.

In some embodiments, the method comprises: receiving a request message from the first supervisory entity, indicating that the first supervisory entity seeks a suitable match for the first target entity; sending said request message only to a subset of users who are supervisory entities, and not to users who are target entities; enabling private communication between (i) the first supervisory entity and (ii) at least one other entity who is a supervisory entity that proposes a match suitable for said second target entity.

In some embodiments, the method comprises: receiving from the first supervisory entity a digital incentive token having real-life monetary value that is greater than zero; notifying to at least one of (i) the first target entity and (ii) the second target entity, that said digital incentive token was provided by the first supervisory entity; transferring said digital incentive token to at least one of (i) the first target entity and (ii) the second target entity, if one or more pre-defined conditions hold true, wherein the one or more pre-defined conditions were pre-defined by the first supervisory entity.

In some embodiments, the digital incentive token comprises one or more of: a digital token for a pre-paid credit at an online retailer; a digital token for a pre-paid credit at an offline retailer; a digital token for a pre-paid gift card; a digital token for a pre-paid food item; a digital token for a pre-paid beverage item; a digital token for a pre-paid ticket for entering a venue.

In some embodiments, the method comprises: enabling communications among a plurality of supervisory entities, with regard to matching among two or more target entities, via secure communication channels that are not accessible to any of said target entities; wherein each of said plurality of supervisory entities, has access to profiles of said two or more target entities. In some embodiments, a first Target Entity may respond that he is not interested in the proposed match, and may refer or re-direct the proposed match to another particular Target Entity that he knows, and/or to a parent/Supervisory Entity of another Target Entity that he knows. In some embodiments, a Supervisory Entity may respond that he is not interested in the proposed match for his related or associated Target Entity (e.g., for his child), and may refer or re-direct the proposed match to another particular Target Entity that he knows, and/or to a parent/Supervisory Entity that he knows and that is associated with another Target Entity. In some embodiments, any participant, or at least some participant(s), in such “chain” of initiating/referring/proposing/responding/re-directing of a match proposal, may be allocated a reward or prize or award or other incentive by the system. In some embodiments, optionally, prior to proposing a match, and/or in parallel to proposing a match by one Supervisory Entity to another Supervisory Entity (or to a Target Entity), the system may generate and transmit a success prediction query to a third-party Advisor, in order to obtain from such Advisor a feedback with regard to the predicted or estimated success (or failure) of such potential match; in some embodiments, the proposed match may be automatically canceled by the system, or may be deleted or discarded, or a negative feedback about it may be transmitted to the initiating Supervising Entity or to the other (receiving) Supervising Entity, if the system receives from such third-party Advisor a feedback indicating low success or poor success (e.g., relative to a pre-defined threshold value) or negative success prediction.

In some embodiments, the method comprises: enabling communications among a plurality of supervisory entities, to exchange information regarding possible matching of a particular target entity with another target entity, via secure communication channels that are not accessible to any of said target entities; wherein each of said plurality of supervisory entities, has access to profiles of said particular target entity.

In some embodiments, the method comprises: determining whether a current user is operating as a supervisory entity or as a target entity; if the current user is operating as a supervisory entity, then: presenting to the current user a first advertisement that is pre-defined as suitable for supervisory entities; if the current user is operating as a target entity, then: presenting to the current user a second advertisement that is pre-defined as suitable for target entities.

In some embodiments, the method comprises: generating a leaderboard that ranks supervisory entities, based at least on the number of successful matches of target entities that said supervisory entities were involved in.

In some embodiments, the method comprises: generating a leaderboard that ranks supervisory entities, based at least on the number of matching advices that said supervisory entities provide to other supervisory entities.

In some embodiments, an initial profile of the first target entity, cannot be initially created by the first target entity, and can only be initially created by the first supervisory entity.

In some embodiments, the method comprises: performing analysis of one or more data-items or documents, which prove a particular real-life connection between the first supervisory entity and the first target entity, as a condition for creating the association between the first supervisory entity and the first target entity.

In some embodiments, the method comprises: creating the association between the first supervisory entity and the first target entity, based on analysis of data obtained from a social network or from other external repository which indicates existence of a particular real-life connection between the first supervisory entity and the first target entity.

Functions, operations, components and/or features described herein with reference to one or more implementations, may be combined with, or may be utilized in combination with, one or more other functions, operations, components and/or features described herein with reference to one or more other implementations. Some embodiments may comprise any possible or suitable combinations, re-arrangements, assembly, re-assembly, or other utilization of some or all of the modules or functions or components or units that are described herein, even if they are discussed in different locations or different chapters of the above discussion, or even if they are shown across different drawings or multiple drawings.

While certain features of some demonstrative embodiments have been illustrated and described herein, various modifications, substitutions, changes, and equivalents may occur to those skilled in the art. Accordingly, the claims are intended to cover all such modifications, substitutions, changes, and equivalents.

1. A method comprising:
(a) creating a first supervisory account, having a first pair of username and password, for a first entity which is a first Supervisor Entity;
(b) creating a second supervisory account, having a second pair of username and password, for a second entity which is a second Supervisor Entity;
(c) creating a first target account, having a third pair of username and password, for a third entity which is a first Target Entity;
(d) creating a second target account, having a fourth pair of username and password, for a fourth entity which is a second Target Entity;
(e) creating an association between (I) the first supervisory account of the first supervisory entity, and (II) the first target account of the first target entity;
(f) creating an association between (I) the second supervisory account of the second supervisory entity, and (II) the second target account of the second target entity;
(g) receiving from at least one of: (i) the first supervisory account of the first supervisory entity, and (ii) the second supervisory account of the second supervisory entity, a request to create a communication connection between (I) the first target account of the first target entity and (II) the second target account of the second target entity;
(h) based on said request, creating said communication connection between (I) the first target account of the first target entity and (II) the second target account of the second target entity.

2. The method of claim 1,
wherein the creating of step (h) is performed only if said request is approved by both of the first supervisory entity and the second supervisory entity.

3. The method of claim 1,
wherein the creating of step (h) is performed only if said request is approved by (i) the first supervisory entity and (ii) the second supervisory entity and (iii) at least one of the first and second target entities.

4. The method of claim 1,
wherein the creating of step (h) is performed only if said request is approved by (i) the first supervisory entity and (ii) the second supervisory entity and (iii) the first target entity and (iv) the second target entity.

5. The method of claim 4,
wherein step (h) comprises:
creating a private communication connection between (I) the first target account of the first target entity and (II) the second target account of the second target entity,
wherein content of communications performed via said private communication connection are not accessible by the first supervising entity and are not accessible by the second supervising entity.

6. The method of claim 4,
wherein step (h) comprises:
creating a private communication connection between (I) the first target account of the first target entity and (II) the second target account of the second target entity,
wherein content of communications performed via said private communication connection are not accessible by the first supervising entity and are not accessible by the second supervising entity;
providing an indication, to at least one of the first supervising entity the second supervising entity, that a communication session took place via said private communication connection between (I) the first target account of the first target entity and (II) the second target account of the second target entity, while preventing the first and the second supervising entities from accessing the content of said communication session.

7. The method of claim 1, comprising:
enabling the first supervising entity to perform search queries through a database storing profiles of target entities;
providing to the first supervising entity a search result which comprises at least the profile of said second target entity;
providing to the first supervising entity an indication that the second target entity is associated with the second supervisory entity;
enabling a private communication session between the first supervisory entity and the second supervisory entity.

8. The method of claim 1, comprising:
enabling the first supervising entity to perform search queries through a database storing profiles of supervisory entities;
providing to the first supervising entity a search result which comprises at least the profile of said second supervisory entity;
providing to the first supervising entity an indication that the second supervisory entity is associated with the second target entity;
providing to the first supervising entity access to the profile of the second target entity;
enabling a private communication session between the first supervisory entity and the second supervisory entity.

9. The method of claim 1, comprising:
enabling the first supervising entity to perform search queries through a database which stores profiles of supervisory entities and profiles of target entities;
providing to the first supervising entity a search result which comprises at least (i) the profile of said second supervisory entity, and (ii) the profile of said second target entity, and (iii) an indication about the type of association that exists between the second supervisory entity and the second target entity;
providing to the first supervising entity (i) access to the profile of the second target entity, and (ii) access to the profile of the second supervisory entity.

10. The method of claim 1, comprising:
receiving a request message from the first supervisory entity, indicating that the first supervisory entity seeks a suitable match for the first target entity;
sending said request message only to a subset of users who are supervisory entities, and not to users who are target entities;
enabling private communication between (i) the first supervisory entity and (ii) at least one other entity who is a supervisory entity that proposes a match suitable for said second target entity.

11. The method of claim 1, comprising:
receiving from the first supervisory entity a digital incentive token having real-life monetary value that is greater than zero;
notifying to at least one of (i) the first target entity and (ii) the second target entity, that said digital incentive token was provided by the first supervisory entity;
transferring said digital incentive token to at least one of (i) the first target entity and (ii) the second target entity, if one or more pre-defined conditions hold true, wherein the one or more pre-defined conditions were pre-defined by the first supervisory entity.

12. The method of claim 11,
wherein the digital incentive token comprises one or more of:
a digital token for a pre-paid credit at an online retailer;
a digital token for a pre-paid credit at an offline retailer;
a digital token for a pre-paid gift card;
a digital token for a pre-paid food item;
a digital token for a pre-paid beverage item;
a digital token for a pre-paid ticket for entering a venue.

13. The method of claim 1, comprising:
enabling communications among a plurality of supervisory entities, with regard to matching among two or more target entities, via secure communication channels that are not accessible to any of said target entities;
wherein each of said plurality of supervisory entities, has access to profiles of said two or more target entities.

14. The method of claim 1, comprising:
enabling communications among a plurality of supervisory entities, to exchange information regarding possible matching of a particular target entity with another target entity, via secure communication channels that are not accessible to any of said target entities;
wherein each of said plurality of supervisory entities, has access to profiles of said particular target entity.

15. The method of claim 1, comprising:
determining whether a current user is operating as a supervisory entity or as a target entity;
if the current user is operating as a supervisory entity, then: presenting to the current user a first advertisement that is pre-defined as suitable for supervisory entities;
if the current user is operating as a target entity, then: presenting to the current user a second advertisement that is pre-defined as suitable for target entities.

16. The method of claim 1, comprising:
generating a leaderboard that ranks supervisory entities, based at least on the number of successful matches of target entities that said supervisory entities were involved in.

17. The method of claim 1, comprising:
generating a leaderboard that ranks supervisory entities, based at least on the number of matching advices that said supervisory entities provide to other supervisory entities.

18. The method of claim 1,
wherein an initial profile of the first target entity, cannot be initially created by the first target entity, and can only be initially created by the first supervisory entity.

19. The method of claim 1, comprising:
performing analysis of one or more data-items or documents, which prove a particular real-life connection between the first supervisory entity and the first target entity, as a condition for creating the association between the first supervisory entity and the first target entity.

20. The method of claim 1, comprising:
creating the association between the first supervisory entity and the first target entity, based on analysis of data obtained from a social network or from other external repository which indicates existence of a particular real-life connection between the first supervisory entity and the first target entity.

21. A system comprising:
one or more processors, operably associated with one or more memory units, wherein the one or more processors are configured:
(a) to create a first supervisory account, having a first pair of username and password, for a first entity which is a first Supervisor Entity;
(b) to create a second supervisory account, having a second pair of username and password, for a second entity which is a second Supervisor Entity;
(c) to create a first target account, having a third pair of username and password, for a third entity which is a first Target Entity;
(d) to create a second target account, having a fourth pair of username and password, for a fourth entity which is a second Target Entity;
(e) to create an association between (I) the first supervisory account of the first supervisory entity, and (II) the first target account of the first target entity;
(f) to create an association between (I) the second supervisory account of the second supervisory entity, and (II) the second target account of the second target entity;
(g) to receive from at least one of: (i) the first supervisory account of the first supervisory entity, and (ii) the second supervisory account of the second supervisory entity, a request to create a communication connection between (I) the first target account of the first target entity and (II) the second target account of the second target entity;
(h) based on said request, to create said communication connection between (I) the first target account of the first target entity and (II) the second target account of the second target entity.
